(19) United States
(12) Patent Application Publication
(10) Pub. No.: US 2024/0295013 A1
(43) Pub. Date: Sep. 5, 2024

(54) HIGH-ENTROPY ALLOY (HEA) WITH ROOM-TEMPERATURE SUPERPLASTICITY AND PREPARATION METHOD THEREOF

(71) Applicant: Shaanxi University of Technology, Hanzhong (CN)

(72) Inventors: Ran JING, Hanzhong (CN); Xiong ZHANG, Hanzhong (CN); Qing ZHANG, Hanzhong (CN); Taotao AI, Hanzhong (CN); Jianghua LI, Hanzhong (CN); Pengfei CHUI, Hanzhong (CN); Yang ZHANG, Hanzhong (CN); Zhongni LIAO, Hanzhong (CN)

(73) Assignee: Shaanxi University of Technology, Hanzhong (CN)

(21) Appl. No.: 18/424,646

(22) Filed: Jan. 26, 2024

Related U.S. Application Data
(63) Continuation of application No. PCT/CN2023/107182, filed on Jul. 13, 2023.

(30) Foreign Application Priority Data
Mar. 2, 2023 (CN) 202310195077.8

(51) Int. Cl. C22C 30/02; B08B 7/02; C22C 1/02; C23G 1/08

(52) U.S. Cl. CPC C22C 30/02; B08B 7/028; C22C 1/02; C22C 2202/00; C23G 1/086

(57) ABSTRACT

The present disclosure provides a high-entropy alloy (HEA) with room-temperature superplasticity and a preparation method thereof, belonging to the field of metal materials. In the present disclosure, the HEA with room-temperature superplasticity has a chemical formula shown in Formula I: (FeCoNiCr)₁₀₀₋ₓCuₓ (Formula I), where in Formula I, x is 2.0 to 4.0. A FeCoNiCr alloy is used as a matrix, and then added with a trace amount of a Cu element, thereby significantly reducing formation of a metastable phase in the FeCoNiCr alloy while reducing stacking fault energy of the alloy, such that the alloy maintains a desirable work hardening ability and achieves an excellent elongation at break. Moreover, a plasticity of the alloy is further improved through twinning-induced plasticity (TWIP).

### CROSS REFERENCE TO RELATED APPLICATION

The present application claims priority to the Chinese Patent Application No. 202310195077.8, filed with the China National Intellectual Property Administration (CNIPA) on Mar. 2, 2023, and entitled “HIGH-ENTROPY ALLOY (HEA) WITH ROOM-TEMPERATURE SUPERPLASTICITY AND PREPARATION METHOD THEREOF”, which is incorporated herein by reference in its entirety.

### TECHNICAL FIELD

The present disclosure relates to the field of metal materials, in particular to a high-entropy alloy (HEA) with room-temperature superplasticity and a preparation method thereof.

### BACKGROUND

With the rapid development of science and technology in modern times, traditional alloy design methods have reached a limit, and the emergence of high-entropy alloys (HEAs) provides another alloy design idea. However, face-centered cubic HEAs represented by FeCoNiCrMn with an equiatomic ratio shows a desirable elongation (approximately 60%) and the “toughness and strength” at low temperatures, but has a yield strength of generally less than 200 MPa. This greatly limits application of these HEAs in engineering materials. The FeCoNiCrMn is a single-phase alloy, and cannot be strengthened by heat treatment, while the strengthening by traditional work hardening greatly reduces the elongation of the alloy.

Therefore, it has become an urgent technical problem to be solved in this field to provide an HEA with both high strength and ultra-high plasticity.

### SUMMARY

An objective of the present disclosure is to provide a high-entropy alloy (HEA) with room-temperature superplasticity and a preparation method thereof. In the present disclosure, the HEA with room-temperature superplasticity has both high strength and ultra-high plasticity.

To achieve the above objective, the present disclosure provides the following technical solutions:

The present disclosure provides a high-entropy alloy (HEA) with room-temperature superplasticity, where the HEA with room-temperature superplasticity has a chemical formula shown in Formula I:

(FeCoNiCr)₁₀₀₋ₓCuₓ Formula I; and
in Formula I, x is 2.0 to 4.0.

Preferably, in Formula I, x is 2.4 to 3.6.

The present disclosure further provides a preparation method of the HEA with room-temperature superplasticity, including the following steps:
(1) subjecting a raw material to a pretreatment to obtain a high-purity raw material; and
(2) melting the high-purity raw material obtained in step (1) to obtain the HEA with room-temperature superplasticity.

Preferably, the raw material in step (1) includes Ni, Cr, Cu, Fe, and Co.

Preferably, the pretreatment in step (1) includes subjecting the Ni, the Cr, and the Cu to pickling and ultrasonic cleaning and subjecting the Fe and the Co to the ultrasonic cleaning.

Preferably, the pickling is conducted for 50 s to 70 s.

Preferably, the pickling is conducted with a mixed aqueous solution of nitric acid and hydrofluoric acid or a hydrochloric acid solution.

Preferably, the mixed aqueous solution of the nitric acid and the hydrofluoric acid has 10% to 30% of the nitric acid and 5% to 8% of the hydrofluoric acid by mass percentage.

Preferably, the melting in step (2) is conducted in a protective atmosphere.

Preferably, the protective atmosphere is argon.

Preferably, the melting in step (2) is conducted in a melting chamber.

Preferably, before the melting is conducted, the melting chamber is subjected to primary vacuumizing, and a protective atmosphere is introduced until a pointer of a gas valve points to 0 MPa; and then the melting chamber is subjected to secondary vacuumizing, and the protective atmosphere is introduced until the pointer of the gas valve points to −0.05 MPa.

Preferably, the primary vacuumizing is conducted to allow a vacuum degree of greater than or equal to 8.4×10⁻⁴ MPa.

Preferably, the secondary vacuumizing is conducted to allow a vacuum degree of greater than or equal to 3.0×10⁻³ MPa.

Preferably, the melting in step (2) is conducted 3 to 5 times.

Preferably, the melting in step (2) is conducted at 1,950° C. to 2,050° C. for 55 s to 65 s each time.

The present disclosure provides an HEA with room-temperature superplasticity, where the HEA with room-temperature superplasticity has a chemical formula shown in Formula I: (FeCoNiCr)₁₀₀₋ₓCuₓ (Formula I); where in Formula I, x is 2.0 to 4.0. In the HEA with room-temperature superplasticity provided by the present disclosure, a FeCoNiCr alloy is used as a matrix, and then added with a trace amount of a Cu element, which has lower stacking fault energy, thereby significantly reducing formation of a metastable phase in the FeCoNiCr alloy while reducing stacking fault energy of the alloy, such that the alloy maintains a desirable work hardening ability and achieves an excellent elongation at break. Moreover, the Cu element with lower stacking fault energy can promote the formation of twin crystals during alloy deformation, and a plasticity of the alloy is further improved through twinning-induced plasticity (TWIP). Experimental results show that the HEA with room-temperature superplasticity has a hardness of (160-175) HV_{0.2}, a maximum tensile strength of greater than or equal to 490 MPa, a yield strength of greater than or equal to 167 MPa, and an elongation of greater than or equal to 124%, thereby exhibiting high strength and ultra-high plasticity.

### BRIEF DESCRIPTION OF THE DRAWINGS

FIG. 1 shows an X-ray diffraction (XRD) pattern of an HEA with room-temperature superplasticity in Example 1 of the present disclosure;

FIG. 2 shows stress-strain curves of the HEAs with room-temperature superplasticity in Examples 1 and 2; and

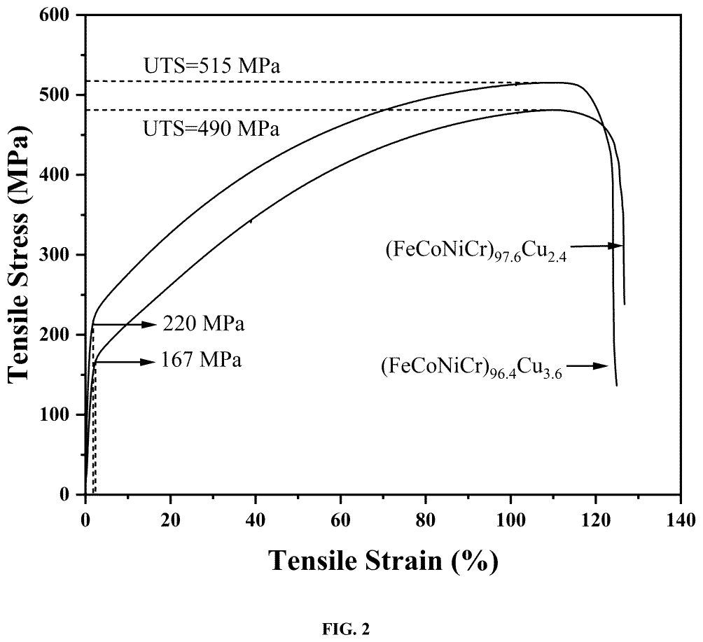

FIG. 3 shows electron back-scattered diffraction (EBSD) data of the HEA with room-temperature superplasticity in Example 1.

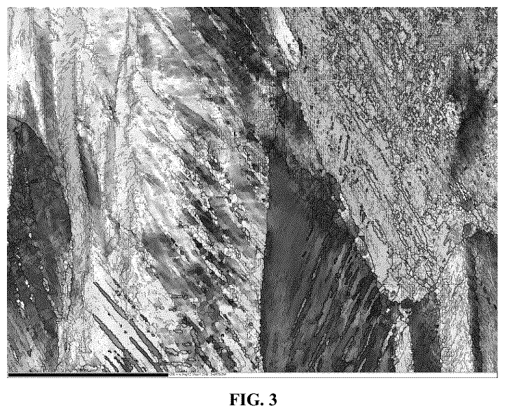

### DETAILED DESCRIPTION OF THE EMBODIMENTS

The present disclosure provides a high-entropy alloy (HEA) with room-temperature superplasticity, where the HEA with room-temperature superplasticity has a chemical formula shown in Formula I:

(FeCoNiCr)₁₀₀₋ₓCuₓ Formula I; and
in Formula I, x is 2.0 to 4.0.

In the present disclosure, in Formula I, x is preferably 2.4 to 3.6, more preferably 3.0. In formula I, x represents an atomic percentage. In the present disclosure, the Cu element with lower stacking fault energy can reduce formation of a metastable phase in the FeCoNiCr alloy, such that the alloy maintains a desirable work hardening ability and achieves an excellent elongation at break. Moreover, the Cu element can promote the formation of twin crystals during alloy deformation, and a plasticity of the alloy is further improved through twinning-induced plasticity (TWIP).

In the HEA with room-temperature superplasticity provided by the present disclosure, a FeCoNiCr alloy is used as a matrix, and then added with a trace amount of a Cu element, which has lower stacking fault energy, thereby significantly reducing formation of a metastable phase in the FeCoNiCr alloy while reducing stacking fault energy of the alloy, such that the alloy maintains a desirable work hardening ability and achieves an excellent elongation at break. Moreover, the Cu element can promote the formation of twin crystals during alloy deformation, and an elongation of the alloy is further increased through TWIP, making the alloy to achieve ultra-high plasticity.

The present disclosure further provides a preparation method of the HEA with room-temperature superplasticity, including the following steps:
(1) subjecting a raw material to a pretreatment to obtain a high-purity raw material; and
(2) melting the high-purity raw material obtained in step (1) to obtain the HEA with room-temperature superplasticity.

In the present disclosure, a raw material is subjected to a pretreatment to obtain a high-purity raw material.

In the present disclosure, the raw material includes preferably Ni, Cr, Cu, Fe, and Co. Errors in alloy composition can be reduced by limiting components in the raw material to the above-mentioned types.

In the present disclosure, the Ni, Cr, Cu, Fe, and Co each have a purity of preferably greater than or equal to 99.9%; and the Ni, Cr, Cu, Fe, and Co each are preferably in the form of particles. Impurities in the alloy can be reduced by limiting the purity of Ni, Cr, Cu, Fe, and Co to the above-mentioned ranges, thereby improving the strength and plasticity of the alloy.

In the present disclosure, the pretreatment includes preferably subjecting the Ni, the Cr, and the Cu to pickling and ultrasonic cleaning, and subjecting the Fe and the Co to ultrasonic cleaning. The impurities in the raw material can be further removed by the pretreatment of the raw material to improve the properties of the alloy.

In the present disclosure, the pickling is preferably conducted with a mixed aqueous solution of nitric acid and hydrofluoric acid or a hydrochloric acid solution, more preferably the mixed aqueous solution of the nitric acid and the hydrofluoric acid; and the pickling is conducted for preferably 50 s to 70 s. There is no special limitation on a specific operation of the pickling, and operations well known to those skilled in the art can be used. The oxide layer on the surface of Ni, Cr, and Cu can be fully removed by limiting a type of the pickling solution and the pickling time in the pickling to the above ranges.

In the present disclosure, the mixed aqueous solution of the nitric acid and the hydrofluoric acid has preferably 10% to 30%, more preferably 15% to 20% of the nitric acid and preferably 5% to 8%, more preferably 5% to 6% of the hydrofluoric acid by mass percentage. The removal effect of the oxide layer on the surface of Ni, Cr, and Cu can be improved by limiting a composition of the mixed aqueous solution of the nitric acid and the hydrofluoric acid to the above ranges.

In the present disclosure, there is no special limitation on a concentration of the hydrochloric acid solution, which can be selected by those skilled in the art according to needs.

In the present disclosure, a solvent for the ultrasonic cleaning of Ni, Cr, and Cu is preferably absolute ethanol. There is no special limitation on operations and a cleaning time of the ultrasonic cleaning, and the pickling solution on the surface of Ni, Cr, and Cu can be cleaned by conventional operations.

In the present disclosure, a solvent for the ultrasonic cleaning of Fe and Co is preferably absolute ethanol. There is no special limitation on operations and a cleaning time of the ultrasonic cleaning, and fouling on the surface of Fe and Co can be cleaned by conventional operations.

In the present disclosure, after the pretreatment is completed, a pretreated raw material is preferably dried to obtain the high-purity raw material.

In the present disclosure, the drying is preferably conducted by blowing with a hair dryer. There is no special limitation on a drying time, as long as the raw material can be blown until it is completely dried.

In the present disclosure, the high-purity raw material is melted to obtain the HEA with room-temperature superplasticity.

In the present disclosure, the melting is preferably conducted in a protective atmosphere; and the protective atmosphere is preferably argon. The melting can be conducted in the protective atmosphere to avoid alloy oxidation and reduce the plasticity of the alloy.

In the present disclosure, the melting is preferably conducted in a melting chamber. Preferably, before melting is conducted, the melting chamber is subjected to primary vacuumizing, and a protective atmosphere is introduced until a pointer of a gas valve points to 0 MPa; and then the melting chamber is subjected to secondary vacuumizing, and the protective atmosphere is introduced until the pointer of the gas valve points to −0.05 MPa.

In the present disclosure, the primary vacuumizing is conducted to allow a vacuum degree of preferably greater than or equal to 8.4×10⁻⁴ MPa. Oxidation of the alloy during melting can be avoided by limiting the vacuum degree to the above range.

In the present disclosure, the secondary vacuumizing is conducted to allow a vacuum degree of preferably greater than or equal to 3.0×10⁻³ MPa. The oxidation of the alloy during melting can be further avoided by limiting the vacuum degree of the secondary vacuumizing to the above range.

In the present disclosure, a crucible used for the melting is preferably a water-cooled copper crucible. The alloy can be made to have a higher cooling rate by limiting a type of the crucible to be within the above range.

In the present disclosure, the melting is conducted preferably 3 to 5 times; and the melting is conducted at preferably 1,950° C. to 2,050° C., more preferably 2,000° C. for preferably 55 s to 65 s, more preferably 60 s each time. Various parameters of the melting can be set within the above ranges to improve the strength and plasticity of the alloy.

In the present disclosure, the melting is conducted at a current of preferably 190 A to 240 A. Occurrence of shrinkage cavities during the melting can be avoided by setting the melting current within the above range.

In the present disclosure, a stirring current is preferably turned on during the melting. There is no special limitation on a magnitude of the stirring current, as long as a molten alloy can be rotated uniformly. The compositional homogeneity of a resulting ingot is ensured by turning on the stirring current.

In the present disclosure, after the melting is finished, an alloy obtained by the melting is preferably cooled to a room temperature and then wiped to obtain the HEA with room-temperature superplasticity.

In the present disclosure, the cooling is preferably achieved by furnace cooling.

In the present disclosure, a solvent used for the wiping is preferably absolute ethanol. There is no special limitation on a wiping operation, as long as dirt on a surface of the alloy can be wiped off.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the protection scope of the present disclosure.

### EXAMPLE 1

This example provided an HEA with room-temperature superplasticity, where the HEA with room-temperature superplasticity had a chemical formula of Fe_{24.4}Co_{24.4}Ni_{24.4}Cr_{24.4}Cu_{2.4}.

A preparation method of the HEA with room-temperature superplasticity included the following steps:
(1) Ni, Cr, and Cu particles were pickled for 1 min to remove an oxide layer on the surface, obtained pickled materials were put into absolute ethanol to allow ultrasonic cleaning, while Fe and Co particles were put into absolute ethanol to allow ultrasonic cleaning, and obtained cleaned raw materials were completely dried with a hair dryer to obtain a high-purity raw material; where the pickling was conducted with a mixed aqueous solution of nitric acid and hydrofluoric acid; and the mixed aqueous solution of the nitric acid and the hydrofluoric acid had 15% of the nitric acid and 5% of the hydrofluoric acid by mass percentage.
(2) The high-purity raw material obtained in step (1) was weighed according to a composition ratio, and a total weight of the raw material was 50 g; the high-purity raw material was put into a water-cooled copper crucible, a melting chamber was closed, primary vacuumizing was conducted to a vacuum degree of 8.4×10⁻⁴ MPa; after reaching the above vacuum degree, argon was introduced until a pointer of a gas valve pointed to 0 MPa, secondary vacuumizing was conducted to a vacuum degree of 3.0×10⁻³ MPa, and then argon was introduced again until the pointer of the gas valve pointed to-0.05 MPa; melting was conducted at a current of 210 A by turning over 3 to 5 times, where a stirring current was turned on during the melting to ensure the uniformity of the composition of an ingot; after the melting was finished, the melting chamber was cooled to room temperature, a sample was removed from the melting chamber, and surface dirt on the sample was wiped off with absolute ethanol to obtain the HEA with room-temperature superplasticity; where the melting was conducted at 2,000° C. for 60 s each time.

### EXAMPLE 2

This example provided an HEA with room-temperature superplasticity, where the HEA with room-temperature superplasticity had a chemical formula of Fe_{24.1}Co_{24.1}Ni_{24.1}Cr_{24.1}Cu_{3.6}.

A preparation method of the HEA with room-temperature superplasticity included the following steps:
(1) Ni, Cr, and Cu particles were pickled for 1 min to remove an oxide layer on the surface, obtained pickled materials were put into absolute ethanol to allow ultrasonic cleaning, while Fe and Co particles were put into absolute ethanol to allow ultrasonic cleaning, and obtained cleaned raw materials were completely dried with a hair dryer to obtain a high-purity raw material; where the pickling was conducted with a mixed aqueous solution of nitric acid and hydrofluoric acid; and the mixed aqueous solution of the nitric acid and the hydrofluoric acid had 15% of the nitric acid and 5% of the hydrofluoric acid by mass percentage.
(2) The high-purity raw material obtained in step (1) was weighed according to a composition ratio, and a total weight of the raw material was 50 g; the high-purity raw material was put into a water-cooled copper crucible, a melting chamber was closed, primary vacuumizing was conducted to a vacuum degree of 8.4×10⁻⁴ MPa; after reaching the above vacuum degree, argon was introduced until a pointer of a gas valve pointed to 0 MPa, secondary vacuumizing was conducted to a vacuum degree of 3.0×10⁻³ MPa, and then argon was introduced again until the pointer of the gas valve pointed to-0.05 MPa; melting was conducted at a current of 210 A by turning over 3 to 5 times, where a stirring current was turned on during the melting to ensure the uniformity of the composition of an ingot; after the melting was finished, the melting chamber was cooled to room temperature, a sample was removed from the melting chamber, and surface dirt on the sample was wiped off with absolute ethanol to obtain the HEA with room-temperature superplasticity; where the melting was conducted at 2,000° C. for 60 s each time.

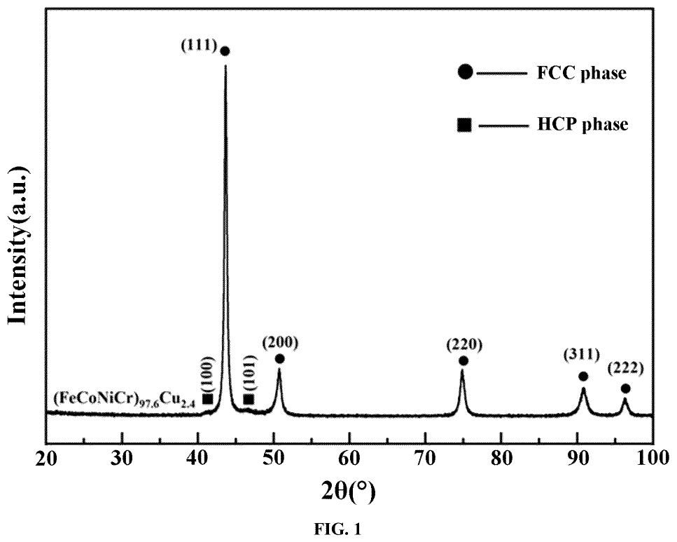

The phase analysis of the HEA with room-temperature superplasticity prepared in Example 1 was conducted with a Japanese Rigaku D/max-2500 X-ray diffractometer (XRD), and an obtained XRD pattern was shown in FIG. 1. The working parameters of the test process included: Cu target Kα radiation, a working voltage of 40 kV, a scanning speed of 1°/min, a scanning range of 20° to 100°, and an alloy sample size of 10 mm×10 mm×2 mm. Before the test, the sample was polished to 1500 # with sandpaper, and an obtained polished sample was subjected to ultrasonic cleaning in alcohol for 2 min to 3 min, and then dried with cold air for later use.

The HEAs with room-temperature superplasticity prepared in Examples 1 and 2 were tested for its tensile properties, and a specific testing method was as follows:

A room-temperature tensile test of the alloy was conducted with a CMT5150 electronic universal testing machine, where a tensile sample had a gauge length of 6 mm and a tensile rate of 0.18 mm/min.

TABLE 1
Properties of HEAs with room-temperature superplasticity
prepared in Examples 1 and 2

| | Properties | | |
|---|---|---|---|
| | Maximum tensile | Yield | |
| Example | strength (MPa) | strength (MPa) | Elongation (%) |
| Example 1 | 490 | 167 | 127 |
| Example 2 | 515 | 220 | 124 |

As shown in the XRD pattern of FIG. 1, a composition of the HEA with room-temperature superplasticity prepared in Example 1 included a face-centered cubic phase and an extremely small amount of hexagonal close-packed phases.

As could be seen clearly from the properties of the HEAs with room-temperature superplasticity prepared by Examples 1 and 2 in Table 1, the HEA with room-temperature superplasticity had a maximum tensile strength of greater than or equal to 490 MPa, a yield strength of greater than or equal to 167 MPa, and an elongation of greater than or equal to 124%, thereby ensuring an ultra-high plasticity and a high strength.

In the present disclosure, the traditional alloy design method is combined with FeCoNiCr HEA as a matrix. By adjusting the components in a small amount, a Cu element with lower stacking fault energy is added. By further controlling the vacuum degree, protective atmosphere, and melting current during the melting, an HEA with room-temperature superplasticity is prepared. This provides a complete technical route for the composition design and preparation of the HEA with room-temperature superplasticity.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A high-entropy alloy (HEA) with room-temperature superplasticity, wherein the HEA with room-temperature superplasticity has a chemical formula shown in Formula I:
(FeCoNiCr)100-xCux Formula I; and
in Formula I, x is 2.0 to 4.0.

2. The HEA with room-temperature superplasticity according to claim 1, wherein in Formula I, x is 2.4 to 3.6.

3. A preparation method of the HEA with room-temperature superplasticity according to claim 1, comprising the following steps:
(1) subjecting a raw material to a pretreatment to obtain a high-purity raw material; and
(2) melting the high-purity raw material obtained in step (1) to obtain the HEA with room-temperature superplasticity.

4. The preparation method according to claim 3, wherein the raw material in step (1) comprises Ni, Cr, Cu, Fe, and Co.

5. The preparation method according to claim 4, wherein the pretreatment in step (1) comprises subjecting the Ni, the Cr, and the Cu to pickling and ultrasonic cleaning and subjecting the Fe and the Co to the ultrasonic cleaning.

6. The preparation method according to claim 5, wherein the pickling is conducted for 50 s to 70 s.

7. The preparation method according to claim 5, wherein the pickling is conducted with a mixed aqueous solution of nitric acid and hydrofluoric acid or a hydrochloric acid solution.

8. The preparation method according to claim 7, wherein the mixed aqueous solution of the nitric acid and the hydrofluoric acid has 10% to 30% of the nitric acid and 5% to 8% of the hydrofluoric acid by mass percentage.

9. The preparation method according to claim 3, wherein the melting in step (2) is conducted in a protective atmosphere.

10. The preparation method according to claim 9, wherein the protective atmosphere is argon.

11. The production method according to claim 3, wherein the melting in step (2) is conducted in a melting chamber.

12. The preparation method according to claim 11, wherein before the melting is conducted, the melting chamber is subjected to primary vacuumizing, and a protective atmosphere is introduced until a pointer of a gas valve points to 0 MPa; and then the melting chamber is subjected to secondary vacuumizing, and the protective atmosphere is introduced until the pointer of the gas valve points to −0.05 MPa.

13. The preparation method according to claim 12, wherein the primary vacuumizing is conducted to allow a vacuum degree of greater than or equal to 8.4×10−4 MPa.

14. The preparation method according to claim 12, wherein the secondary vacuumizing is conducted to allow a vacuum degree of greater than or equal to 3.0×10−3 MPa.

15. The preparation method according to claim 3, wherein the melting in step (2) is conducted 3 to 5 times.

16. The preparation method according to claim 15, wherein the melting in step (2) is conducted at 1,950° C. to 2,050° C. for 55 s to 65 s each time.

17. The preparation method according to claim 3, wherein in Formula I, x is 2.4 to 3.6.

18. The preparation method according to claim 17, wherein the raw material in step (1) comprises Ni, Cr, Cu, Fe, and Co.

19. The preparation method according to claim 18, wherein the pretreatment in step (1) comprises subjecting the Ni, the Cr, and the Cu to pickling and ultrasonic cleaning and subjecting the Fe and the Co to the ultrasonic cleaning.

20. The preparation method according to claim 19, wherein the pickling is conducted for 50 s to 70 s.
